(19) United States
(12) Patent Application Publication
(10) Pub. No.: US 2007/0266653 A1
(43) Pub. Date: Nov. 22, 2007

(54) COMBINATION WINDOW, SCREEN, STORM SHUTTER AND FIRE ESCAPE

(76) Inventors: Luis E. Martinez, Orange Park, FL (US); Anthony L. Watkins, Middleburg, FL (US)

Correspondence Address: JAMES RAY WOOD, 2254 PALM DALE DRIVE SW, WYOMING, MI, 49519, US

(21) Appl. No.: 11/551,260

(22) Filed: Oct. 20, 2006

Related U.S. Application Data
(60) Provisional application No. 60/728,699, filed on Oct. 20, 2005.

(51) Int. Cl. E06B 1/36

(52) U.S. Cl. 52/204.1

(57) ABSTRACT

A combination window assembly, screen, storm shutter and fire escape includes a fixed frame mounted into the building wall. A horizontally movable window frame, screen and storm shutter are positioned in the fixed frame, whereby each can be moved from a position covering an open portion of the frame to a position within a recess. The window assembly is operable, such that a component of the window can be opened when the window assembly is positioned in the open portion.

### PRIORITY CLAIM

This application claims priority from U.S. Provisional Application No. 60/728,699, filed Oct. 20, 2005, entitled “Combination Window, Screen, Storm Shutter and Fired Escape”, which is hereby incorporated by reference.

### BACKGROUND OF THE INVENTION

This invention relates generally to the field of window structures in residential or commercial buildings, and more particularly to such structures that incorporate an operable window, a screen, and a storm shutter.

Operable windows of various types are well known. Operable windows, such as single-hung, double-hung, casement, awning or hopper types, have a sash assembly composed of stiles and rails that retain the window glass, the sash being movable relative to the frame such that a portion of the window can be opened to allow for air flow or cleaning. The sash may slide vertically or horizontally, or the sash may be mounted on pivoting means such that the sash can be swung outward, with the pivoting means or hinges being on the top, side or bottom. With the single-hung or double-hung windows where the sash moves vertically, the operable portion of the window is typically half of the window or less.

It is common to provide a screen to cover the portion of the window that is open to prevent the passage of insects and debris. For single-hung and double-hung windows, the screen is usually mounted within the window frame external to the window, with the screen covering only the sash and not the fixed window portion. For hinged windows, affixing a screen is often impractical unless the windows are mechanically operated, since the user must have access to the sash in order to open and close the window.

It is also known to provide storm or hurricane shutters on the exterior of the window frame to prevent damage to the window during high wind conditions, or to provide security shutters or grates to prevent unauthorized entry into the building through the window. In a simple embodiment the shutters are mounted to the exterior of the window frame so as to cover the window glass. In other embodiments the shutters are slid horizontally from a hidden position within a housing across the window glass. Accordion-style shutters are also known, where the shutter occupies a relatively small area within a housing when not in use.

The known window structure combinations that include windows, screens and/or storm shutters present several problems that heretofore have not been addressed. For single-hung and double-hung windows, which are by far the most common window structure found in buildings, only a portion of the total area of the opening covered by the window, typically a half or less, can be opened to allow air passage. Thus, the amount of air flow is not maximized, since air can only pass through the opening created by re-positioning of the sash. If hinged windows are present, use of a screen it usually precluded, meaning that the user cannot prevent insects and debris from passing through the window opening. With storm and security shutters, the shutters must be resist any deformation from impacts of flying objects, since the glass window remains in position behind the shutter, meaning that excessive thickness must be engineered into the shutter. In addition, since most sashes provide relatively small openings through the window frame, it is often impossible for adults to climb through the opening in the event of fire or other emergency.

It is an object of this invention to address all of the problems with a single window structure, such that the user has the option of creating an opening substantially equal to the entire window frame area for the passage of air and has the ability to cover this entire opening with a screen regardless of the type of operable that is in place. In addition, it is a further object to provide such a window structure wherein a storm shutter can be shifted into position over the window opening while simultaneously shifting the window and frame out of the opening, and wherein the entire window and frame can be shifted out of the opening in order to provide a large opening for escape from the building.

### SUMMARY OF THE INVENTION

A window structure for a building, either residential or commercial includes an operable window and window frame, a screen and a storm shutter, disposed within a fixed frame mounted within the wall of the building. The fixed frame includes a recess and an open portion, whereby the operable window and window frame, the screen and the storm shutter are independently movable from an in-use position covering the fixed frame open portion to a non-use position out of the fixed frame open portion and within the fixed frame recess. Means to allow independent horizontal movement of the operable window and frame, the screen and the storm shutter are provided, whereby the exposed fixed frame open portion can be covered singularly or by any combination of the three non-stationary components the operable—window and window frame, the screen and the storm shutter—or by none of the components such that the entire open portion is unblocked for use as an emergency exit.

### BRIEF DESCRIPTION OF THE DRAWINGS

FIG. 1 is a view showing the fixed frame with the operable window and window frame in place within the open portion, and with the screen and storm shutter partially positioned within the fixed frame recess.

FIG. 2 is a view similar to FIG. 1, where the operable window and window frame is shown being moved from the open portion of the fixed frame to the fixed frame recess to present a non-blocked open recess, the screen and storm shutter being removed from the illustration for clarity.

FIG. 3 is an end view showing the track members of the fixed frame.

FIG. 4 is an end view showing an alternative embodiment of the track members of the fixed frame.

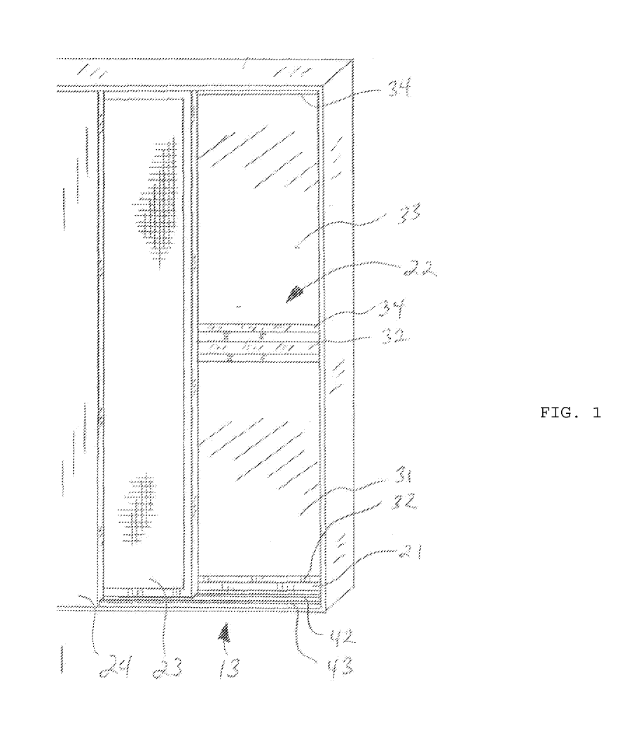

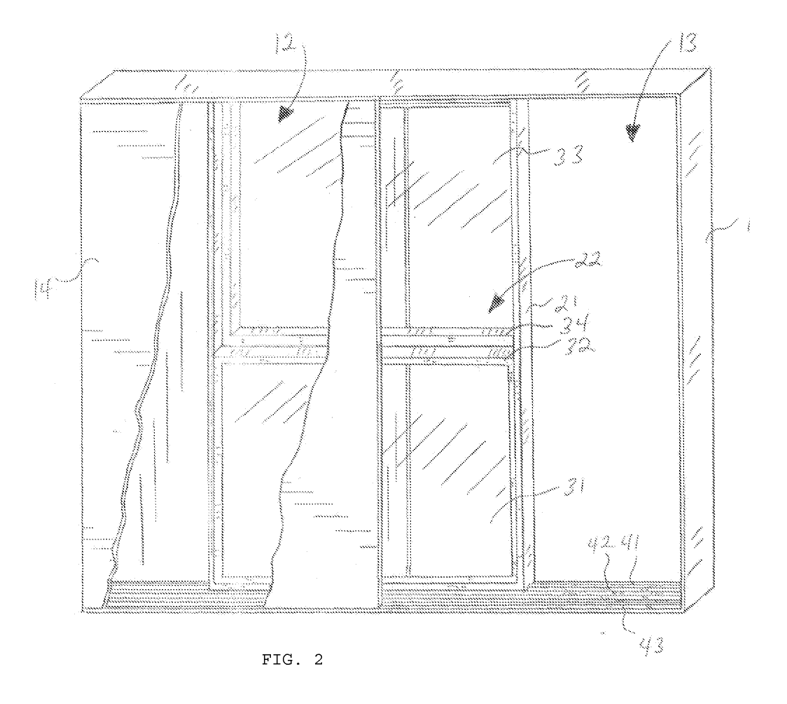

### DETAILED DESCRIPTION OF THE EMBODIMENT

With reference to the drawings, the invention will now be described in detail with regard for the best mode and the preferred embodiment.

The invention comprises a generally rectangular fixed frame 11 that is adapted to be positioned within the walls of a building. The fixed frame 11 comprises a fixed frame recess 12 and an open portion 13, the fixed frame recess 12 being structured so as to receive in concealed manner a non-fixed window frame 21 with operable window assembly 22, a non-fixed screen 23 and a non-fixed storm shutter 24, wherein the window frame 21 with operable window assembly 22, screen 23, and storm shutter 24 are movable between a hidden position entirely within the fixed frame recess 12 and an exposed position entirely within the open portion 13. The window frame 21 with operable window assembly 22, screen 23 and storm shutter 24 are mounted in a co-planar manner. The fixed frame recess 12 may be covered by panels 14 in order to conceal the window frame 21 with operable window assembly 22, screen 23 and storm shutter 24, or the concealment may be accomplished by a combination of the fixed frame 11 and the exterior and interior walls of the building.

The operable window assembly 22 is disposed within the window frame 21 in a known manner, such that the operable window assembly 22 may be opened to allow passage of air. The operable window assembly 22 may comprise standard window configurations such as single-hung, double-hung, casement, awning or hopper types, where one part of the window assembly 22 is vertically movable relative to the other stationary part, where both parts are vertically movable, or where the entire window is movable in a hinged manner.

A single-hung window assembly 22 is illustrated in the drawings, with the window assembly 22 comprising a pane 31 mounted in a movable sash 32 to form the lower portion of the window assembly 22 and a pane 33 mounted in a fixed sash 34 to form the upper portion of windows assembly 22. The fixed sash 34 is mounted in stationary manner to the upper part of the window frame 21 and the movable sash 32 is mounted in known manner in the window frame 21 within vertical guides (not shown) such that the movable sash 32 may be raised and lowered relative to the fixed sash 34, thereby providing an air passage through the lower portion of the window frame 21.

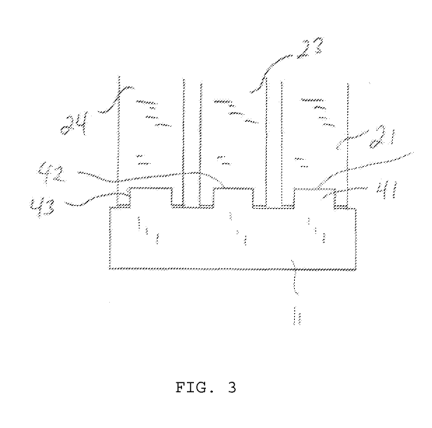

The window frame 21 is mounted within the fixed frame 11 utilizing horizontal movement means that allows the entire window frame 21 and window assembly 22 to be moved horizontally relative to the fixed frame 11. The horizontal movement means may comprise any known system that facilitates horizontal movement of the window frame 21, and as shown in FIG. 3 comprises a track member 41 that is received within a slot 35 disposed in the sill of window frame 21. Alternatively, as shown in FIG. 4, the track member 41 may comprise a longitudinal recess or channel of sufficient width to receive the sill of window frame 21. Wheels, rollers, slides or other friction-reducing means may also be provided. In like manner the screen 23 and the storm shutter 24 are also retained by track members 42 and 43, respectively. Screen 23 and storm shutter may be structured in known manner.

With the fixed frame member 11 securely mounted in the building wall, the most common status of the invention is to have the storm shutter 24 and screen 23 positioned within the fixed frame recess 12, such that they are concealed from view, and the window frame positioned in the open portion 13 of the fixed frame 11. The window assembly 22 is fully operational in this position, such that the user may open the window assembly 22 if desired. For single-hung, double-hung or inwardly opening hinged window assemblies 22, the user also has the option of pulling the screen 23 from the recess 12 such that insects and debris are precluded from passing through. Alternatively, if a larger air passage is desired, the window frame 21 is moved into the recess 12 such that only the screen 23 covers the open portion 13 of the fixed frame in hostile weather circumstances such as strong storms or hurricanes, the storm shutter 24 is moved from the recess 12 to cover the open portion 13. The screen 23 and window frame 21 may be left in place to present multiple barriers, or they may be moved into the recess 12 for increased protection. Finally, in the event of an emergency requiring rapid exit of the building, the window frame 21, screen 23 and storm shutter 24 may all be moved into the recess 12, such that the open portion 13 of fixed frame 11 is not obstructed in any way, enabling occupants to easily exit through the large open portion 13.

The above description is of the preferred embodiment. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

The embodiments of the invention in which an exclusive property or privilege is claimed are defined as follows:

1. A window structure for mounting within a wall of a building, the window structure having a fixed frame, an operable window, a window frame, a storm shutter and a screen, where the fixed frame includes a recess and an open portion, whereby the operable window, window frame, the screen and the storm shutter are independently movable from an in-use position covering the open portion to a non-use position out of the fixed frame open portion and within the recess.

2. The window structure of claim 1 further comprising means to allow independent horizontal movement of the operable window, window frame, the screen and the storm shutter, whereby the open portion can be covered singularly or by any combination of the window frame, the screen and the storm shutter.

3. A window structure adapted to be positioned within a wall of a building, comprising:
a fixed frame having a fixed frame recess and an open portion, the fixed frame structured so as to receive within the fixed frame recess a horizontally movable window frame.

4. The window structure of claim 3 where the fixed frame is structured to receive within the fixed frame recess a horizontally movable screen.

5. The window structure of claim 4 where the fixed frame is structured to receive within the fixed frame recess a horizontally movable storm shutter.

6. The window structure of claim 5 wherein the horizontally movable window frame, the horizontally movable screen and the horizontally movable storm shutter are mounted in a co-planar manner.

7. The window structure of claim 6 further comprising panels for covering the fixed frame recess.

8. The window structure of claim 3 window structure where the horizontally movable window frame is entirely contained within the fixed frame when the horizontally movable window frame is in a hidden position and the horizontally movable window frame is entirely contained within the open portion when the horizontally movable window frame is in an exposed position.

9. The window structure of claim 8 where the fixed frame is structured to receive within the fixed frame recess a horizontally movable screen such that the horizontally movable screen is entirely contained within the fixed frame when the horizontally movable screen is in the hidden position and the horizontally movable screen is entirely contained within the open portion when the horizontally movable window screen is in the exposed position.

10. The window structure of claim 9 where the fixed frame is structured to receive within the fixed frame recess a horizontally movable storm shutter such that the horizontally movable storm shutter is entirely contained within the fixed frame when the horizontally movable storm shutter is in the hidden position and the horizontally movable storm shutter is entirely contained within the open portion when the horizontally movable storm shutter is in the exposed position.

11. The window structure of claim 5 wherein the horizontally movable window frame, the horizontally movable screen and the horizontally movable storm shutter are mounted in a co-planar manner.

12. The window structure of claim 6 further comprising panels for covering the fixed frame recess.

13. A window structure adapted to be positioned within the walls of a building, comprising:
a fixed frame having a fixed frame recess and an open portion, the fixed frame structured so as to receive within the fixed frame recess a horizontally movable window frame, and horizontal movement means for allowing the horizontally movable storm shutter window frame to be moved horizontally relative to the fixed frame.
